(19) United States
(12) Patent Application Publication
(10) Pub. No.: US 2016/0314637 A1
(43) Pub. Date: Oct. 27, 2016

(54) Coin Wrapping Machine

(71) Applicant: GCCM, LLC, Harrisburg, PA (US)

(72) Inventor: Gregory F. String, Mechanicsburg, PA (US)

(21) Appl. No.: 14/805,884

(22) Filed: Jul. 22, 2015

Related U.S. Application Data
(60) Provisional application No. 62/032,265, filed on Aug. 1, 2014.

(51) Int. Cl. G07D 9/06; B65B 35/56; B65B 35/50; B65B 11/56; B65B 11/00

(52) U.S. Cl. CPC G07D 9/065; B65B 11/56; B65B 11/004; B65B 35/50; B65B 35/56

(57) ABSTRACT

A coin wrapping machine includes an accumulator section and a coin wrapping section. The accumulator section assembles a coin stack and delivers the coin stack to the coin wrapping section. A puff of compressed air is blown against the coin stack to resist coin flutter while the coin stack is being delivered to the coin wrapping section. The coin wrapping section includes a drive roller and idler rollers that wrap a coin wrapper sheet around the coin stack. The idler rollers do not engage the leading tip portions of the wrapper sheets to reduce the likelihood of the wrapper sheets jamming against the idle rollers.

### RELATED APPLICATION

This application claims priority from my co-pending U.S. Provisional Patent Application No. 62/032,265 “Coin Wrapping Machine” filed Aug. 1, 2014 at Attorney Docket No. 1-2059-P, which priority application is incorporated by reference as if fully set forth herein.

### FIELD OF THE DISCLOSURE

This disclosure relates to devices that wrap stacks of coins.

### BACKGROUND OF THE DISCLOSURE

Coin wrapping machines wrap stacks of like-diameter coins with coin wrapper sheets and secure the wrapped sheets around the coin stack without the use of adhesives or glues. An example of a coin wrapping machine that machine-wraps coin stacks is disclosed in Tsuruda et al U.S. Pat. No. 6,519,921, incorporated by reference as if fully set forth herein.

The coin wrapping machine includes an accumulator that receives a singulated stream of coins and arranges the coins in a stack. The formed stack of coins is moved into a coin wrapping section of the coin wrapping machine. A coin wrapper sheet (typically made of kraft paper or the like) is fed off a roll to the coin wrapping section. The coin wrapper sheet is closely wrapped around the coin stack. The upper and lower ends of the sheet are crimped by crimp claws or crimp hooks to mechanically secure the wrapped sheet.

It is desirable to increase the reliability of coin wrapping machines.

### BRIEF SUMMARY OF THE DISCLOSURE

Disclosed is a coin wrapping machine having a coin accumulator that quickly gravity-feeds the coin stack to the coin wrapping section. A burst of air is applied against the top-most coin of the coin stack as the coin stack moves into the coin wrapping section to assure that the coins of the coin stack remain in proper horizontal alignment when received into the coin wrapping section.

The coin wrapping section includes a roller drive assembly that includes a rotary drive member and a drive for the drive member. The drive generates and applies torque causing the drive member to rotate about a vertical drive axis. The drive member engages the coin stack and rotates the coin stack about the vertical stack axis. Idler rollers are spaced around the periphery of the coin stack. Friction between the coin stack and idler rollers cause the idler rollers to rotate with the coin stack. The idler rollers each rotate along a respective vertical axis of rotation. By positively driving only the drive member and friction-driving the idler rollers, construction of the coin wrapping section is simplified and made less expensive.

A leading edge of a coin wrapper sheet is fed between the drive member and the rotating coin stack. Frictional engagement of the drive member against the sheet drives the sheet past the drive member. The sheet is guided around the coin stack in a downstream wrapping direction to wrap the coins, moving between each idle roller and the coin stack to be wrapped around the coin stack.

The leading edge of the coin wrapper sheet reaches each of the idle rollers as the sheet is being driven around the coin stack. The sheet is between the idle roller and the coin stack. Each idle roller is designed to first engage and generate line contact with a portion of the sheet upstream from the leading edge of the sheet, or in other words, a leading portion of the sheet moves in the wrapping direction past the idle roller before the idle roller engages the sheet. In this way, the leading edge of the coin wrapper sheet does not first impact against the idle roller before moving past the idle roller. Such impacts may jam the wrapper against the idle roller and impede further downstream movement of the wrapper sheet.

The idle rollers can be designed to provide clearance for coin wrapper sheets having different leading edge contours or profiles.

The drive member rotates the coin stack at a first relatively lower rotation speed when initially feeding the coin wrapper sheet around the coin stack. After the leading edge of the sheet has passed the last idle roller, the drive member rotates the coin stack at a second, relatively higher rotation speed for operation of the crimp hooks. The lower speed assures smooth feeding of the coin wrapper sheet past the idle rollers. The higher speed assures proper crimping of the ends of the wrapped sheet against the coin stack.

After wrapping and crimping is complete, the wrapped and crimped coin stack fall by gravity out of the coin wrapping section and may fall onto a conveyor or chute for further processing.

Other objects and features of the disclosure will become apparent as the description proceeds, especially when taken in conjunction with the accompanying drawing sheets illustrating one or more non-limiting embodiments.

### BRIEF DESCRIPTION OF THE DRAWINGS

FIG. 1 is a schematic side view of a coin wrapping machine;

FIG. 2 is a side view of the accumulator of the coin wrapping machine of FIG. 1, a stack of coins in the stack holding area of the accumulator and a partial stack of coins being formed in the stack-forming area of the accumulator;

FIG. 3 is a simplified top view of the coin wrapping section of the coin wrapping machine;

FIG. 4 is a side view of the coin wrapping section shown in FIG. 3, a stack of coins in the coin wrapping section and a coin wrapper sheet being fed to the coin wrapping section;

FIG. 5 illustrates the leading edge of a coin wrapper sheet being fed into the coin wrapping section shown in FIG. 4;

FIG. 6 is a developed view of a second coin wrapper sheet usable with the coin wrapping machine shown in FIGS. 1-4;

FIG. 7 illustrates a second embodiment idle roller suitable for use with the coin wrapper sheets shown in FIGS. 5 and 6; and

FIG. 8 illustrates a third embodiment idle roller suitable for use with coin wrapper sheet in FIG. 6.

### DETAILED DESCRIPTION

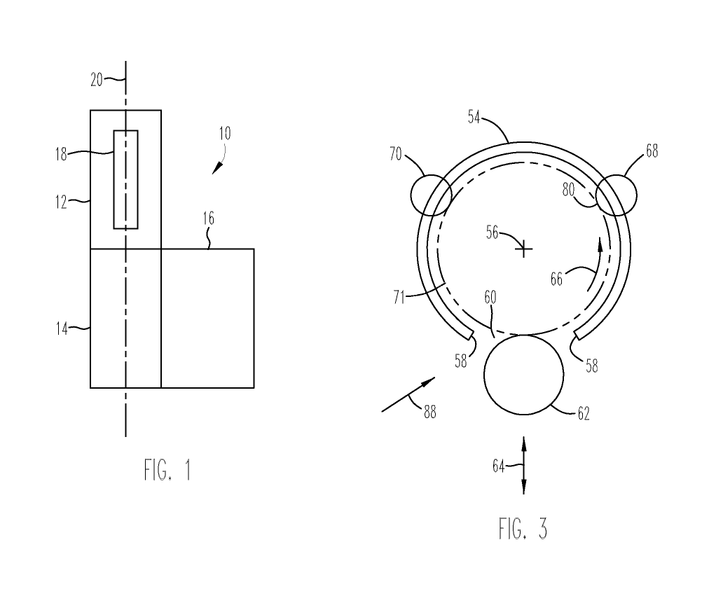

FIG. 1 schematically illustrates a coin wrapping machine having an accumulator 12 disposed above a coin wrapping section 14. Adjacent the coin wrapping section 14 is a sheet feed station 16 that feeds coin wrapper sheets to the coin wrapping section 14. The sheet feed station 16 is conventional and so will not be described in greater detail.

The accumulator 12 forms a stack of coins 18 coaxial with a vertical axis 20 that extends through the accumulator 12 and through the coin wrapping section 14. The stack of coins 18 gravity-drop from the accumulator 12 along the vertical axis 20 and into the coin wrapping section 14. After dropping into the coin wrapping section 14 the stack of coins are wrapped by a coin wrapper sheet fed from the sheet feed station 16.

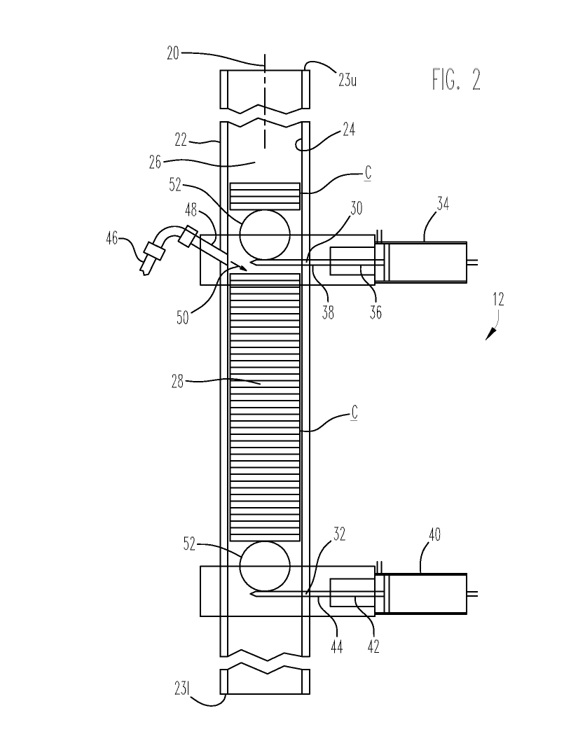

FIG. 2 is a side view of the accumulator 12 of the coin wrapping machine 10. The accumulator 12 forms a stack of like coins to be wrapped. A stack of like US coins of is conventionally formed from 20, 25, 40, or 50 coins (depending on denomination).

The accumulator 12 includes a coin receiving tube 22 that is coaxial with and extends along the vertical axis 20. The coin receiving tube 22 extends from an open upper end 23u to an open lower end 231. The interior tube wall 24 has a circular cross-section sized to receive coins of a specific diameter or denomination. The coin receiving tube 22 is divided into an upper stack-forming or pre-stack area 26 and a lower stack holding area 28. A first horizontal slot opening 30 extends through the tube wall 24 and separates the pre-stack area 26 from the stack holding area 28. A second horizontal slot opening 32 extends through the tube wall 24 and defines the lower end of the stack holding area 28.

A first pneumatic cylinder 34 located adjacent to the slot opening 30 has a piston rod 36 attached to a horizontal plate 38 for reciprocal movement along a horizontal axis through the slot opening 30. The plate 38 is movable between an extended position shown in FIG. 2 where the plate 38 is inside the tube 22 and a retracted position (not shown) outside of the tube 22. When the plate 38 is in its extended position the plate 38 forms the floor of the stack-forming area 26.

The pneumatic cylinder 34 or an additional vibratory drive can also be configured and operated to vibrate or oscillate the plate 38 horizontally at a relatively high frequency when the plate 38 is in the extended position.

A second pneumatic cylinder 40 located adjacent to the slot opening 32 has a piston rod 42 attached to a horizontal plate 44 for reciprocal movement along a horizontal axis through the slot opening 32. The plate 44 is movable between an extended position shown in FIG. 2 and a retracted position (not shown) outside of the tube 22. When the plate 44 is in its extended position the plate 44 forms the floor of the stack holding area 28.

The pneumatic cylinder 40 or an additional vibratory drive can also be configured and operated to vibrate or oscillate the plate 44 horizontally at a relatively high frequency when the plate 38 is in the extended position.

A compressed air line 46 is attached to a source of compressed air (not shown) and includes a discharge nozzle 48 that extends through the tube wall 24 just vertically below the horizontal plane of movement of the plate 38. The discharge nozzle 48 is disposed to selectively discharge compressed air into the tube 22 in a downward direction indicated by the arrow 50.

Operation of the accumulator 12 is discussed next.

A tube 22 is installed in the accumulator 12 sized for the coin diameter or denomination to be wrapped. Initially the tube 22 is empty. The upper plate 38 is in its extended position to close the bottom of the stack-forming area 26. The lower plate 44 is in its extended position to close the bottom of the stack-holding area 28.

A bearing member 52 (the illustrated bearing member 52 is a steel ball bearing) drops through the open upper end 23u of the coin receiving tube 22 and rests on the upper plate 38. Single like-diameter coins C delivered by conveyor or other conventional transport mechanism drop through the open upper end 23u of the tube 22 to begin forming a stack of coins in the stack forming area 26 and resting on the bearing member 46. Vibration or oscillation of the plate 38 while the stack of coins is being formed assists in settling the coins within the tube 22 and forming a satisfactory stack of coins.

The number of coins to be wrapped by a coin wrapping sheet determines the number of coins to be formed into the coin stack.

A sensor (not shown) counts the number of coins being dropped into the tube 22 to form the coin stack. When some, but not all, of the coins that will form the coin stack are collected in the stack-forming area 26, the upper cylinder 34 is actuated to withdraw the plate 38 from the tube 22. For example, the cylinder 34 may retract the plate 38 when 31 coins of a 40-coin stack or when 41 coins of a 50-coin stack are in the stack-forming area 26. The bearing member 52 and the partial coin stack fall in the tube 22 to the stack holding area 28 and are supported on the lower plate 44. The plate 44 may also vibrate to settle the coins supported on the plate 44.

Additional coins now drop through the open upper end of the tube 22 and fall onto the coin stack now being formed in the stack holding area 28. When the full number of coins for the coin stack are received in the stack holding area 28, the cylinder 34 is actuated and moves the upper plate 38 back to the extended position in the tube 22. The upper plate 38 thereby recloses the bottom of the stack-forming area 26. The process of forming a partial stack of coins in the stack-forming area 26 begins again.

FIG. 2 illustrates the accumulator 12 with a 40-coin stack of US nickels C being held in the stack holding area 28 and a partial stack of US nickels C being formed in the stack-forming area 26.

While a partial stack of coins in the stack-forming area 26 is being formed, the coin wrapping section 14 (described in further detail below) signals that it is ready to receive a coin stack for wrapping. In response, the lower cylinder 40 retracts the lower plate 44, causing the bearing member 52 and the coin stack supported on the bearing member to fall by gravity through the open lower end 231 of the tube 22 and be received in the coin wrapping section 14 of the coin wrapping machine 10.

In the illustrated embodiment a full coin stack drops a greater vertical height dropping from the stack holding area 28 and into the coin wrapping section 14 than a partial coin stack drops from the stack-forming area 26 to the stack holding area 28. As a result of this greater vertical drop, it has been found that occasionally the uppermost coin of the coin stack will “flutter” in the tube 22 while dropping to the coin wrapping section 14 and will end up tilted and not lay horizontal against the next adjacent coin of the coin stack. The tilted coin prevents wrapping of the coin stack.

To eliminate tilting of the uppermost coin caused by flutter, the air line 46 is actuated to discharge a “puff” or stream of compressed air when the lower plate 44 retracts to drop the full coin stack into the coin wrapping section 14. The compressed air stream is directed to impinge against the topmost coin of the coin stack and suppresses or dampens fluttering of that coin. As a result, all the coins of the coin stack are properly aligned flat against one another without tilting when received into the coin wrapping section 14.

After the coin stack falls into the coin wrapping section 14, the lower cylinder 40 moves the plate 44 back to its extended position to close the bottom of the stack holding area 28 in preparation for receiving another partial stack of coins.

FIG. 3 is a simplified top view of the coin wrapping section 14 of the coin wrapping machine. A “C” shaped coin receiving tube 54 extends along a vertical axis 56 coaxial with the axis 20 and perpendicular to the drawing sheet. The vertically-extending and circumferentially spaced-apart ends 58 of the tube 54 define an opening or slot 60 extending parallel with the tube axis 56. The tube axis 56 is coaxial with the vertical axis of the accumulator tube 22 so that the coin tube 54 is disposed to receive the bearing member 52 and the coin stack dropped from the stack holding area 14.

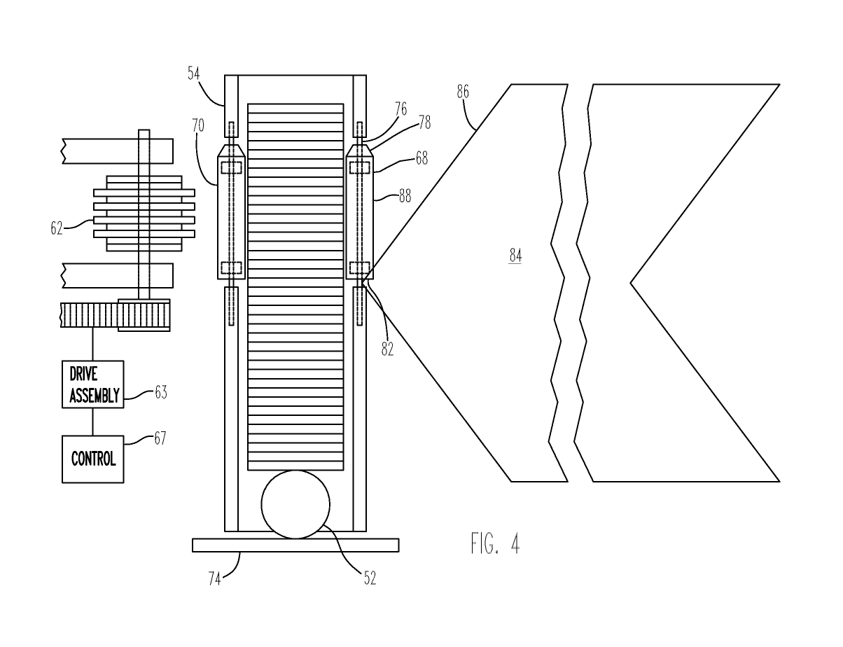

A rotatable, elongate drive member 62 is adjacent the opening 60 in the tube 52 and rotates along a rotation axis parallel with the tube axis 56. The drive member 62 is driven by a drive assembly 63 (see FIG. 4) that includes a conventional rotary belt drive for rotating the drive member 62 and a conventional translation drive for translating the drive member towards and away from the tube opening 60 along a path indicated by the double-ended arrow 64. The drive member 62 is movable along the path 64 between a retracted position away from the tube 54 and a working position wherein the drive member 62 is received in the opening 60 so as to be engageable with the coin stack to rotate the coin stack in the direction indicated by the arrow 66. An automatic control system 67 (see FIG. 4) operates and controls the drive assembly 63 and sets the working position of the drive member 62 as required for the diameter of the coin stack being wrapped.

The tube 54 includes additional vertically elongate slots circumferentially spaced from one another and from the opening 60. The slots receive idle rollers 68, 70 that are journaled in the tube 54 for rotation about vertical axes of rotation parallel to the axis 56. The idle rollers 68, 70 are not driven rollers but are free to rotate as will be described in further detail below.

The outer surfaces of the idle rollers 68, 70 cooperate with the outer surface of the drive member 62 to define a circular cylinder 71 tangential with the drive member 62 and the idle rollers 68, 70 that extends parallel with the tube axis. The diameter of the cylinder 71 varies with movement of the drive member 62 along the path 64.

FIG. 4 is a side view of the coin wrapping section 14 containing a coin stack 72 to be wrapped. The coin stack 72 is supported against a retractable floor 74. The bearing member 52 spaces the coin stack 72 away from the floor 74 to locate the top and bottom ends of the coin stack 72 in the desired vertical alignment with the sheet feeding station 16 and the crimp hooks (not shown).

The illustrated embodiment includes two idle rollers 68, 70 spaced around the circumference of the coin tube 52; additional idle rollers can be used if desired. The idle rollers 68, 70 are identical and so only idle roller 68 will be described.

The idle roller 66 includes a spindle 76 that is parallel with the tube axis 56 and whose ends are carried within the wall of the tube 52. Mounted on the spindle 76 for free rotation about the spindle axis is a larger diameter roller shaft 78. The roller shaft 78 has an elongate uniform-diameter body portion 80 that extends from a lower end 82 upwardly and parallel to the tube axis 56. The lower end 82 is located a slight distance above the center or midplane of a coin stack held in the tube 52 for wrapping. The importance of this feature will be discussed in more detail below. As can be seen in FIG. 3, the radially inner side of the roller shaft body portion 80 is slightly inside the inner wall of the tube 52.

Operation of the coin wrapper section 14 is described next.

A coin receiving tube 54 and the idle rollers 68, 70 are installed in the coin wrapping section 14. The coin receiving tube 54 is sized to receive the coin diameter or denomination to be wrapped. The idle rollers 68, 70 are selected based on the coin diameter or denomination to be wrapped, and, as described in more detail below, based on the shape of the leading end of the coin wrapping sheet to be used for wrapping. Operation of the coin wrapper section 14 utilizing conventional coin wrapper sheets having a “V”-shaped leading end will be described.

The floor 74 is placed in its operating position shown in FIG. 4 to close the coin receiving tube 54. A stack of coins 72 and the bearing member 52 falls from the accumulator 12 to properly place the coin stack 72 into position in the coin wrapping section 14 for wrapping as previously described. The drive member 62 is moved from its retracted position to its working position to be placed against the coin stack 72. The drive member 62 and the idler rollers 68, 70 now define a cylinder 71 tangential with the drive member and idle rollers and whose diameter is effectively the same diameter as the coin stack. The drive member 62 urges the coin stack 72 against the idle rollers 68, 70, causing the drive member 62 and the idle rollers 68, 70 to engage and press against coins of the coin stack. The rotary drive causes the drive member 62 to rotate at a first, relatively slower rotation speed. Friction causes the coin stack 72 and the idler rollers 68, 70, to also rotate at the first speed.

A coin wrapper sheet 84 having a conventional “V” shaped leading end 86 is cut from a supply roll (not shown) and fed along a feed path 88 (see FIG. 3) into a pinch point between the drive member 62 and the coin stack 72.

The drive member 62 feeds the wrapper sheet 84 against the inner wall of the tube 54 whereby the inner wall of the tube 54 guides the sheet 84 in a downstream direction around the coin stack 72. The sheet 84 first passes the upstream idle roller 68 and then the downstream idle roller 68 as the sheet wraps around the coin stack 72.

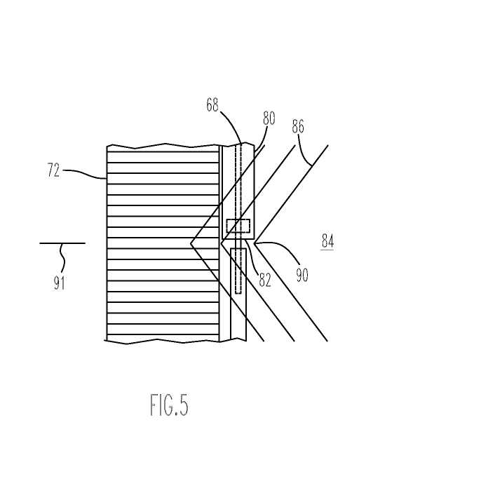

FIG. 5 illustrates the sheet leading end 86 approaching and passing the upstream idle roller 68 as the sheet 84 is driven in the circumferential direction around the coin stack 72. The tip portion 90 of the leading edge 76 is horizontally aligned with the center or midplane of the coin stack 72 and so is slightly below the lower end 82 of the roller shaft body portion 80 when the tip portion 90 reaches the idle roller 68. The tip portion 90 begins to move past the idle roller 68 without the sheet 84 contacting the idle roller 68. As the tip portion 90 of the sheet leading end 86 moves past the idle roller 68, an upstream portion of the sheet leading end 86 enters the pinch point between the idler roller 68 and the coin stack 72. The outer surface of the roller shaft body portion 80 engages the upper portion of the leading end 86 away from or upstream from the sheet tip portion 90. The roller shaft portion 80 begins to make line contact with the wrapper upstream from the tip portion 90. Because the tip 90 has already began moving past the idle roller 68 without touching the idle roller 68, movement of the sheet 84 past the idle roller 68 is not initially impeded by contact of the tip portion 90 with any portion of the idle roller 68. Continued motion of the sheet 84 past the idle roller 68 is guided and urged by the line contact between the sheet 84 and the idle roller body portion 80.

The sheet 86 moves past the downstream idle roller 70 without being impeded in like same manner as described immediately above with relation to the upstream idle roller 68.

After the leading end 86 of the coin wrapper sheet 84 passes the last downstream idle roller 68, the rotation speed of the drive member 62 increases to rotate the coin stack at a second, higher rotation speed. Conventional crimping hooks (not shown) then approach the ends of the coin stack 68 to crimp the upper and lower ends of the tube being formed by the coin wrapping sheet 76 being wrapped around the coin stack 72. Conventionally the length of the coin wrapper sheet 84 is sufficient to wrap two layers of sheet around the coin stack.

After wrapping and crimping, the floor 70 is retracted and the bearing member 52 and the now wrapped-and-crimped coin stack 72 fall by gravity out of the coin wrapping section 14 and onto a chute or conveyor (not shown) for further processing. The bearing member 52 is re-circulated to the accumulator 12 for reuse.

The illustrated coin wrapper sheet 86 is a conventional coin wrapper sheet in which a single “V” cutter cuts the “V” shaped trailing end of one coin wrapper sheet from a supply roll while thereby simultaneously cutting the “V” shaped leading end of the next following coin wrapper sheet yet to be cut away from the supply roll. The tip portion 90 of the leading end 86 of the sheet 84 is the leading-most portion of the sheet 84, that is, the tip portion 90 leads or precedes the remainder of the sheet 84 along the feed path 88 and around the coin stack 72 during wrapping.

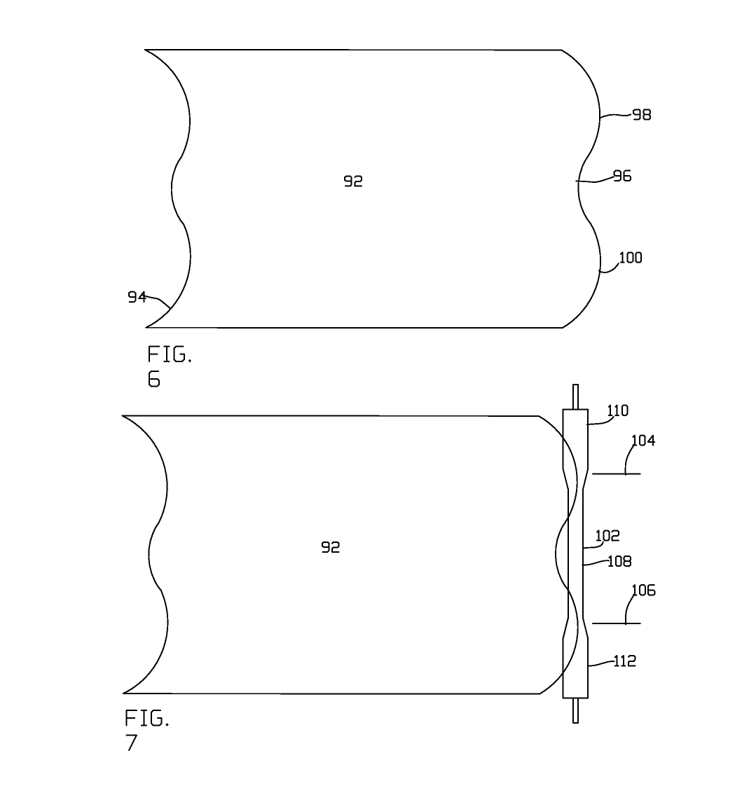

FIG. 6 illustrates a second embodiment coin wrapper sheet 92 cut from the supply roll by a “W” shaped cutter that cuts a “W” shaped trailing end 94 of one coin wrapper sheet while simultaneously cutting a “W” shaped leading end 96 of the following coin wrapper sheet. The leading end 96 of the coin wrapper sheet 92 has two spaced-apart, rounded tip portions 98, 100 that are the leading-most portions of the sheet 92. The tip portions 98, 100 lead or precede the remainder of the leading end of the sheet 92 along the feed path 88 and around the coin stack during wrapping.

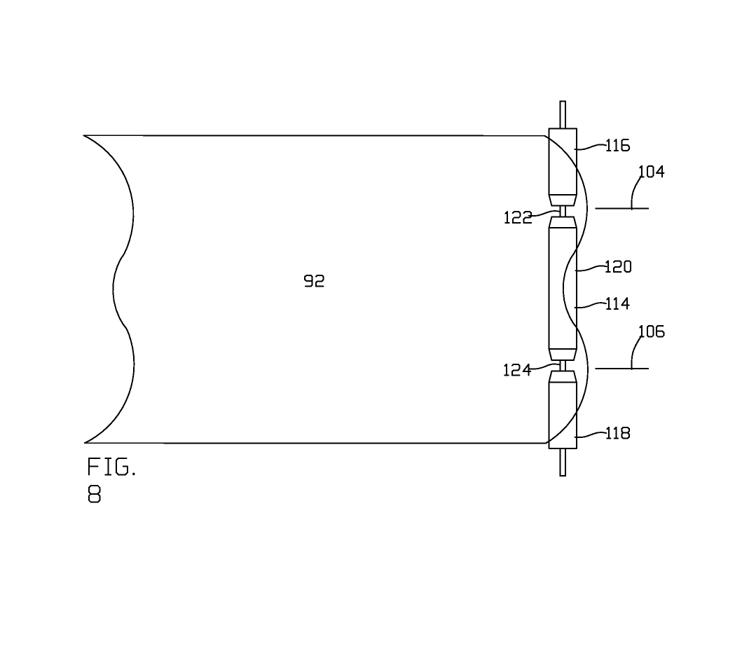

FIG. 7 illustrates an idle roller 102 configured for use in the coin wrapping section 14 when wrapping coin wrapping sheets 92 having a “W” shaped leading end 96. The idle roller 102 is shown over a coin wrapping sheet 92, with the idle roller 102 and the sheet 92 in the same relative position along the rotational axis of the roller 102 as during wrapping of the coin stack. The leading tip portions 98, 100 of the sheet 92 move along developed longitudinal axes 104, 106 as the sheet 92 moves past the roller 102 and around the coin stack.

In this embodiment the idle roller 102 extends along a substantial length of the coin stack and has an intermediate reduced diameter portion 104 that separates axially opposite larger diameter body portions 110, 112. The coin tube used in the coin wrapping section 14 is modified from the illustrated coin tube 52 such that the idle roller 102 is vertically centered with the center or midplane of the coin stack being wrapped. The enlarged diameter body portions 110, 112 are spaced above and below respective tip axes 104, 106 and enable the leading tips 98, 100 of the sheet 92 to move past the idle roller 102 without engaging the idle roller 102. The enlarged diameter portions 110, 112 first engage upper and lower portions of the sheet 92 away from the tips 98, 100 after the tips 98, 100 have moved past the idle roller 102 to guide the sheet 92 around the coin stack 72.

The roller shaft 102 can also be used with the “V” sheet 84 because the sheet leading end 86 moves past the reduced diameter portion 108 and the enlarged diameter portions 110, 112 first engage the sheet 84 away from the leading end 86.

FIG. 8 illustrates an idle roller 114 for use with “W” wrapping sheets 92. The idle roller 114 includes upper and lower large-diameter portions 116, 118 disposed on opposite sides of a centered large diameter portion 120. The upper roller portion 116 and the centered roller portion 120 are spaced apart by a reduced-diameter portion 122 that is aligned with the tip axis 104. The lower roller portion 118 and the centered portion 120 are spaced apart by a reduced-diameter portion 124 that is aligned with the tip axis 106. The roller portion 118 and the roller portion 120

The reduced-diameter roller portions 122, 124 enable the leading tip portions 98, 100 of the sheet 92 to move past the idle roller 114 without engaging the idle roller 114. The large-diameter roller portions 116, 118, 120 then engage and make line contact with the leading end of the wrapper sheet 92 away from the leading tip portions 98, 100 after the tip portions 98, 100 have moved past the roller 114.

The coin receiving tubes 22, 54 are preferably formed as a single integral tube that carries the idle rollers. This enables quick and efficient setup of the coin wrapping machine 10 change out of the tubes and idle rollers when transitioning from one coin denomination to another.

Another embodiment of an idle roller suitable for use with a “W” sheet 92 is similar to the idle roller 114 but includes only one large-diameter portion 116 or 118. Yet another embodiment of an idle roller suitable for use with a “W” sheet 92 omits the center large diameter portion 120 and may optionally omit one of the large-diameter portions 116, 118. An idle roller having a single large diameter portion 116 or large diameter portion 118 is similar to the idle roller 68 but with the large diameter portion of the idle roller positioned adjacent a respective tip axis 104 or tip axis 106.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art and fall within the purview of the following claims.

1. A coin wrapping machine for wrapping a coin stack made of coins having a coin diameter with a wrapper, the coin wrapping machine comprising:
a drive roller operatively connected to a roller drive, a first idler roller, and a second idler roller, each roller being rotatable about a respective axis of rotation, the roller axes of rotation being parallel with one another; the roller drive being disposed and adapted to selectively rotate the drive roller about the drive roller axis of rotation;
the drive roller having an outer surface, and the first idler roller and the second idler roller each comprising a drive portion with an outer surface with a circular cross-section perpendicular to the roller axis;
the drive roller, the first idler roller, and the second idler roller each being disposable in a respective operating position wherein the outer surfaces of the drive roller, the first idler roller, and the second idler roller together define a circular cylinder tangent to said outer surfaces when the rollers are in their respective operating positions, the circular cylinder having a diameter substantially equal to the coin diameter, the circular cylinder extending along an axis parallel to the roller axes of rotation, the drive roller, the first idler roller, and the second idler roller each being disposed outside of the circular cylinder when in the operating position so as to be engageable against an outer periphery of coins of the coin stack when the coin stack is received between the drive roller, the first idler roller, and the second idler roller when the rollers are in their operating positions.

2. The coin wrapping machine of claim 1 wherein the drive roller is disposed and configured to selectively translate the drive roller to and from the operating position of the drive roller to a standby position away from the circular cylinder.

3. The coin wrapping machine of claim 1 comprising a tubular member having a longitudinal axis coaxial with the cylinder axis, the tubular member comprising an arcuate wall bounding the interior of the tubular member, the first and second idler rollers being journaled in the wall of the tubular member.

4. The coin wrapping machine of claim 3 wherein the first and second idler rollers are received in respective slots formed in the arcuate wall.

5. The coin wrapping machine of claim 1 comprising a tubular member having a longitudinal axis coaxial with the cylinder axis, the tubular member comprising an arcuate wall bounding the interior of the tubular member and a slot extending axially in the wall, the drive roller being received in the slot when the drive roller is in the operating position.

6. The coin wrapping machine of claim 1 wherein the wrapper is of the type having a leading end that precedes the remainder of the wrapper around the coin stack during wrapping, the leading end having a leading tip portion that precedes the remainder of the leading end, wherein:
the first and second idle rollers each comprise a reduced diameter second portion adjacent the first portion;
the drive roller, the first idler roller, and the second idler roller are adapted and cooperatively disposed to feed the sheet in a downstream direction from the drive roller, past the first idler roller, and then past the second idler roller when wrapping the sheet around the coin stack;
the second portion of the first and second idler rollers each being disposed to overlay the leading tip portion of the sheet when the leading end of the sheet moves past such first and second idler roller, the first portion of the first and second idler rollers each being disposed to overlay and contact the leading end of the sheet upstream from the leading end of the wrapper when the leading end of the sheet moves past such first and second idler roller.

7. The coin wrapping machine of claim 6 wherein the first and second idler rollers are configured to wrap a wrapper having a “V”-shaped leading end around the coin stack.

8. The coin wrapping machine of claim 6 wherein the first and second idler rollers are configured to wrap a wrapper having a “W”-shaped leading end.

9. The coin wrapping machine of claim 6 wherein each of the first and second idler rollers comprise a reduced diameter third portion, the first outer portion being disposed between the second and third portions.

10. The coin wrapping machine of claim 6 wherein the first and second idler rollers are configured to wrap a wrapper having a “W”-shaped leading end around the coin stack, the leading tip portion of the leading end having first and second leading tip portions spaced apart from each other, wherein:
the second and third portions of each of the first and second idler rollers are disposed to overlay respective first and second leading tip portions of the sheet as the leading end of the sheet moves past such first and second idler roller.

11. The coin wrapping machine of claim 1 wherein the coin stack moves along the longitudinal axis of the cylinder prior to engagement with the rollers, the coin wrapping machine comprising an air nozzle being disposed along the longitudinal axis and being aimed to discharge a jet of air against the coin stack moving along the longitudinal axis.

12. The coin wrapping machine of claim 1 wherein the coin stack moves in a downstream direction along the longitudinal axis and the air nozzle is disposed to discharge the jet of air against an upstream end of the coin stack.

13. The coin wrapping machine of claim 1 comprising a floor being disposable in an operating position to support the coin stack when the coin stack is engaged by the rollers, the floor being movable between the operating position and a standby position away from the operating position to close and open the tubular member.

14. The coin wrapping machine of claim 13 wherein the coin stack is supported on a support member that spaces the coin stack from the floor while the coin stack is being wrapped.

15. The coin wrapping machine of claim 14 wherein the support member is a spherical member.

16. The coin wrapping machine of claim 14 wherein the support member is recycled to an accumulation station where coin stacks are assembled, a coin stack supported on a recycled support member during assembly of the coin stack.

17. The coin wrapping machine of claim 1 comprising a tubular member being adapted and disposed to receive the coin stack for wrapping, the tubular member extending from the rollers to an accumulation station where coins are assembled to form the coin stack, the coin stack being disposed in the tubular member during assembly of the coin stack.

18. The coin wrapping machine of claim 17 wherein the coin stack in the accumulation station is supported on a first valving member after being formed, the first valving member being movable between an operating position inside the tubular member to support the coin stack and a standby position outside of the tubular member.

19. The coin wrapping machine of claim 18 wherein the coin stack is supported on a second valving member spaced from the first valving member while the coin stack is at least partially being assembled, the second valving member being movable between an operating position inside the tubular member to support the coin stack during assembly and a standby position outside of the tubular member.

20. The coin wrapping machine of claim 17 wherein the coin stack moves through the tubular member out of the accumulation station to between the rollers for wrapping, an air nozzle being disposed and operable to discharge a jet of air against the coin stack when the coin stack is moving out of the accumulation station.
